(19) United States
(12) Patent Application Publication
(10) Pub. No.: US 2005/0064321 A1
(43) Pub. Date: Mar. 24, 2005

(54) Positive photoresist composition for liquid crystal device

(76) Inventors: Hoon Kang, Seoul (KR); Joon-Yeon Cho, Gyeonggi-do (KR); Dong-Min Kim, Gyeonggi-do (KR); Seung-Uk Lee, Seoul (KR)

Correspondence Address: FISH & RICHARDSON PC, 225 FRANKLIN ST, BOSTON, MA, 02110, US

(21) Appl. No.: 10/494,486

(22) PCT Filed: Oct. 21, 2002
(86) PCT No.: PCT/KR02/01967

(30) Foreign Application Priority Data
Oct. 31, 2001 (KR) 2001-67576

(51) Int. Cl. G03C 1/494

(52) U.S. Cl. 430/270.1

(57) ABSTRACT

The present invention relates to an LCD circuit photoresist composition for manufacturing fine circuit patterns on liquid crystal display circuits or semiconductor integrated circuits, and more particularly, and LCD circuit photoresist composition including (a) mixed polymer resins comprising a novolak resin with a molecular weight ranging from 3,000 to 9,000 and a fractionated novolak resin with a molecular weight ranging from 3,500 to 10,000; (b) a diazide-type photosensitive compound; (c) a photosensitizer; and (d) organic solvents. An LCD circuit photoresist composition of the present invention has excellent photosensitivity, retention ratio, resolution, contrast, heat resistance, adhesion, and stripper solubility, thus this photoresist composition can be easily applied to industrial work places for better working environments.

### BACKGROUND OF THE INVENTION

(a) Field of the Invention

The present invention relates to an LCD circuit photoresist composition for manufacturing fine circuit patterns on liquid crystal display circuits or semiconductor integrated circuits, and more particularly, to an LCD circuit photoresist composition including polymer resins that produce a photoresist layer, a photosensitive compound, and organic solvents.

(b) Description of the Related Art

For fabricating fine circuit patterns on liquid crystal display circuits or semiconductor integrated circuits, an LCD circuit photoresist composition is uniformly coated or applied on an insulating layer or a conductive metal layer of a substrate. The coated LCD circuit photoresist composition is then exposed through a mask with some form, and the exposed substrate is developed to produce a desired pattern. The patterned photoresist coating is used as a mask to remove the insulating layer or the conductive metal layer, and the remaining photoresist coating is removed to complete the fine pattern onto the substrate surface.

An LCD circuit photoresist composition is classified as a negative type or a positive type depending on whether the exposed area or photoresist coating becomes insoluble or soluble.

The important properties of LCD circuit photoresist compositions for commercial use are photosensitivity, contrast, resolution, adhesion with a substrate, retention ratio, CD uniformity, and safety.

Photosensitivity refers to how fast an LCD circuit photoresist responds to light. High photosensitivity is required, particularly in applications where a number of exposures are performed to form multiple patterns by a repeated process. Another example is when reduced light is used, like with the projection exposure techniques that use light passed through a series of lenses and monochromatic filters.

Improved photosensitivity is essential for a thin film transistor-LCD (TFT-LCD) that needs a long exposure time because of its bigger display size. Photosensitivity is inversely proportional to retention ratio, and the retention ratio tends to reduce with higher photosensitivity.

Contrast refers to a ratio between the percentage of film loss in the exposed development area and the percentage of film loss on the unexposed area. Ordinarily, development of an exposed photoresist coated substrate is continued until the coating on the exposed area is completely dissolved away. Thus, development contrast can be determined simply by measuring the percentage of film coating loss in the unexposed areas when the exposed coating areas are removed entirely.

Resolution refers to how finely a photoresist composition reproduces the image of the mask utilized during exposure on the developed exposed spaces.

In many industrial applications, particularly in the manufacture of LCDs or semiconductor integrated circuits, an LCD circuit photoresist is required to provide a high degree of resolution for very fine lines and space widths of 10 μm or less.

Adhesion with various substrates is one of the physical properties that is required of an LCD circuit photoresist composition. Adhesion increases selectivity by the existence of patterns on fine circuits during removing a conductive metal layer or an insulating layer by a wet etching process.

Generally, an LCD circuit photoresist composition includes polymer resins that produce a photoresist layer, a photosensitive compound, and solvents. Various attempts have been previously made to improve the photosensitivity, contrast, resolution, and the safety of LCD circuit photoresist compositions.

As examples, U.S. Pat. No. 3,666,473 discloses a compound of a mixture of two phenol formaldehyde novolak resins together with a typical photosensitive chemical; U.S. Pat. No. 4,115,128 discloses an organic acid cyclic anhydride added to a phenolic resin and a naphthoquinone diazide photosensitive chemical to increase photosensitivity; U.S. Pat. No. 4,550,069 discloses novolak resin, a o-quinone diazide photosensitive chemical, and propylene glycol alkyl ether acetate solvent being used for higher photosensitivity and for increased safety; and JP. Pat. No. 189,739 discloses a fractionating novolak resin for increasing resolution and heat resistance. The above are well known in the related arts.

Various solvents have been developed to improve physical properties of an LCD circuit photoresist composition as well as work safety. For example, ethylene glycol mono ethyl ether acetate, propylene glycol mono ethyl ether acetate, or ethyl lactate may be used as a solvent. However, there is still a need for LCD circuit photoresist compositions that are suitable for various industrial applications, without sacrificing any one of the properties of photosensitivity, retention ratio, contrast, resolution, solubility of polymer resin, adhesion with a substrate, or CD uniformity.

### SUMMARY OF THE INVENTION

It is an object of the present invention to provide a composition for an LCD circuit photoresist that exhibits high photosensitivity, retention ratio, contrast, resolution, CD uniformity, and adhesion with a substrate, considering previous technical problems.

It is another object of the present invention to provide semiconductor devices using a photoresist composition as above.

In order to achieve these objects, the present invention provides an LCD circuit photoresist composition including polymer resins, a photosensitive chemical, a photosensitizer, and organic solvents, for forming a photoresist film comprising;

(a) mixed polymer resins comprising a novolak resin with a molecular weight ranging from 3,000 to 9,000 and a fractionated novolak resin with a molecular weight ranging from 3,500 to 10,000; (b) a diazide-type photosensitive compound; (c) a photosensitizer; and (d) organic solvents.

Furthermore, the present invention provides semiconductor devices using said photoresist composition to be coated on a conductive metal layer or an insulating layer for forming a photoresist pattern by exposing and developing steps and being removed by etching and stripping steps.

### DETAILED DESCRIPTION OF THE PREFERRED EMBODIMENTS

The present invention will now be explained in detail.

The present invention relates to an LCD circuit photoresist composition using mixed polymer resins comprising a novolak resin and a fractionated novolak resin, to improve physical properties such as photosensitivity, retention ratio, adhesion, etc. of the photoresist layer.

In the photoresist composition of the present invention, the (a) polymer resins include a novolak resin, and more preferably a mixture of a novolak resin and a fractionated novolak resin.

Said fractionation represents that the molecular weight of the polymer resin is arbitrarily controlled by adjusting the ratio among high, medium, or low molecular resins by using organic solvents.

The useful polymer resins employed in the photoresist composition of the present invention are well known in the related arts, however a novolak resin is also used in the present invention. The above novolak resin is a polymer produced by reacting an aromatic alcohol such as phenol, meta, and/or para cresol with formaldehyde.

The characteristic of the present Invention is that a fractionated novolak resin produced by properly removing high, medium, and low molecular resins is used with a novolak resin for improving the function of an LCD circuit photoresist.

The physical properties of the said novolak resin such as photosensitivity, retention ratio etc. are different according to the mixture ratio of meta/para cresols. The amount of meta cresol is preferably 40 to 60 parts by weight, and that of para cresol is 40 to 60 parts by weight. Meta cresol exceeding the above range brings high photosensitivity that decreases the retention ratio, while para cresol exceeding the above range brings low photosensitivity. An LCD circuit photoresist composition has a thermal flow because of the remaining heat on a pattern after a hard-bake process. The line width and gradient of the substrate after the hard-bake process can be controlled by either manipulating the ratio of meta/para cresols or manipulating the molecular weight of polymer resins, then treating it with vapor plasma.

The molecular weight of the novolak resin used in the present invention preferably ranges from 3,000 to 9,000, and the molecular weight of the fractionated novolak resin preferably ranges from 3,500 to 10,000. The mixture ratio of said novolak resin and fractionated novolak resin is preferably 10 to 90 parts by weight: 90 to 10 parts by weight.

The content of polymer resins used in the present invention is 5 to 30 wt %. If it is less than 5 wt %, the viscosity will be too low to coat with a desired thickness, and if it becomes more than 30 wt %, the viscosity will be too high to coat uniformly.

The above (b) photosensitive compound is a diazide-type compound, such as 2,3,4,-trihydroxybenzophenone-1,2-naphthoquinonediazide-5-sulfonate obtained by esterification of trihydroxybenzophenone and 2-diazo-1-naphthol-5-sulfonic acid, and 2,3,4,4′-tetrahydroxybenzophenone-1,2-naphthoquinonediazide-5-sulfonate obtained by esterification of tetrahydroxybenzophenone and 2-diazo-1-naphthol-5-sulfonic acid. Each of these can be used independently or in combination.

The diazide-type photosensitive compounds mentioned above are obtained by reacting diazide-type compounds such as polyhydroxybenzophenone, 1,2-naphthoquinonediazide, and 2-diazo-1-naphtho-5sulfonic acid.

Two methods for controlling photosensitivity by using a photosensitive compound are diversifying the amount of photosensitive compound, and controlling the speed of esterification of 2,3,4-trihydroxybenzophenone or 2,3,4,4′-tetrahydroxybenzophenone and 2-diazo-1-naphthol-5-sulfonic acid.

More preferably, the above photosensitive compound includes a mixture of 2,3,4,4′-tetrahydroxybenzophenone-1,2-naphthoquinonediazide-5-sulfonate and 2,3,4,-trihydroxybenzophenone-1,2-naphthoquinonediazide-5-sulfonate. The mixture ratio of these two compounds should be 30 to 70 parts by weight: 70 to 30 parts by weight.

The content of the above photosensitive compound is 2 to 10 wt %. If the content becomes less than 2 wt %, high photosensitivity decreases the retention ratio, and if it is more than 10 wt %, very low photosensitivity will be shown.

Furthermore, regarding the photoresist composition of the present invention, the (d) photosensitizer is used to increase photosensitivity. The above photosensitizer is preferably a polyhydroxy compound having 2 to 7 phenol-type hydroxy groups with a molecular weight of below 1000.

Useful exemplary photosensitizers are shown below. It is preferable that at least one is selected from the group consisting of 1 to 5.

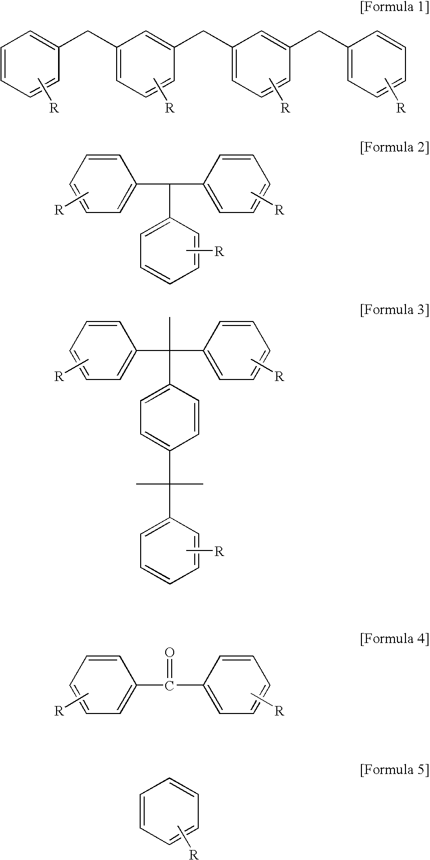

wherein R is hydrogen, —(CH₃)ₙ, —(CH₃CH₂)ₙ, —(OH)ₙ, or a phenyl group, respectively or simultaneously (n is the integral number of 0 to 5).

More preferable examples of the above photosensitizers are 2,3,4-trihydroxybenzophenone, 2,3,4,4′-tetrahydroxybenzophenone, 2,3,4,3′,4′,5′-hexahydroxybenzophenone, condensed acetone-pyrogarol, 4,4-[1-[4-[1-(1,4-hydroxyphenyl)-1-methylethyl]phenyl]ethylidene]bisphenol(TPP A), 4,4-[2-hydroxyphenyl]methylene]bis[2,6-dimethylphenol](BI26X-SA), and others.

Optimal polyhydroxy compounds used above are 4,4-[1-[4-[1-(1,4-hydroxyphenyl)-1-methylethyl]phenyl]ethylidene]bisphenol(TPP A), or 2,3,4,-tirhydroxybenzophenone.

The content of the above photosensitizer is preferably 0.1 to 10 wt %.

A photoresist composition of the present invention comprises (d) organic solvents. Examples of organic solvents here are propylene glycol methyl ether acetate (hereinafter abbreviated to ‘PGMEA’) itself, or PGMEA mixed with ethyl lactate (EL), 2-methoxyethylacetate (MMP), propylene glycol mono methyl ether (PGME), etc. However, PGMEA itself is best.

Additives such as colorants, dyes, anti-striation agents, plasticizers, adhesion promoters, speed enhancers, and surfactants may be added to the LCD circuit photoresist composition of the present invention. Coating such additives on the substrate helps to improve each characterized process performance.

The LCD circuit photoresist composition of the present invention is also used for manufacturing a semiconductor device, and the best example of use of such a semiconductor device is in an LCD circuit manufacturing process.

The photoresist composition of the present invention can be applied to a substrate by such conventional methods as dipping, spraying, whirling, and spin coating. When spin coating, as an example, the photoresist solution can be adjusted with respect to the percentage of solid contents in the spinning process. Suitable substrates include silicon, aluminum, indium tin oxide (ITO), indium zinc oxide (IZO), molybdenum, silicon dioxide, doped silicon dioxide, silicon nitride, tantalum, copper, polysilicon, ceramics, and aluminum/copper mixtures or polymeric resins.

The substrate coated with photoresist composition is heated at 80 to 130° C. to perform soft baking. This step permits the evaporation of the solvent without pyrolysis of a solid component in the photoresist composition. Generally, the concentration of the solvent is preferably reduced to a minimum by the soft-baking step, and thus the soft-baking step is performed until the solvent is mostly evaporated and the LCD circuit photoresist remains on the substrate in a thin coating layer with a thickness of less than 2 μm.

Next, the substrate coated with the photoresist layer is selectively exposed to light, particularly ultraviolet light, using a suitable mask to obtain a desirable pattern. The exposed substrate is then dipped into an aqueous alkaline developing solution until either the exposed photoresist layer is entirely or almost dissolved. Suitable aqueous developing solutions include an aqueous solution including alkaline hydroxides, ammonium hydroxide, or tetra methyl ammonium hydroxide (TMAH).

The substrate with the exposed photoresist removed is then taken out from the developing solution. The resulting substrate is heat-treated to improve it and to increase the adhesion with the substrate and chemical resistance of the photoresist layer. This process is called a hard-baking step. The hard-baking is done at a temperature below the softening point of the photoresist layer, preferably at about 90 to 140° C.

The developed substrate is treated with an etchant or with vapor plasma to etch the exposed portion, and the remaining photoresist protects the substrate regions which it covers. The photoresist layer is removed from the etched substrate using a stripper to complete the pattern on the substrate surface.

The following Examples further illustrate the present invention. However, the scope of the present invention is not limited thereto.

### EXAMPLES

### Synthesis Example 1

### Manufacturing Resins Before and After Fractionation

(Synthesis of Meta/Para Novolak Resins)

45 g of meta cresol, 55 g of para cresol, 65 g of formaldehyde, and 0.5 g of oxalic acid were added to an overhead agitator, and after agitating, a homogenous mixture was synthesized. The reacted composition was heated at 95° C. for 4 hours. A recurrent condenser was replaced with a distiller, then the reacted composition was evaporated at 110° C. for 2 hours. By vacuum evaporation at 180° C. for 2 hours, the monomer residue was removed, and the melted novolak resin was cooled at room temperature. The number average molecular weight was measured by GPC, showing that a novolak resin with a molecular weight of 3500 was obtained (the standard case of polystyrene).

(Fractionation of Novolak Resin)

100/30/100 grams of novolak resin obtained above/PGMEA/toluene were added together and agitated to synthesize a homogeneous mixture, which was then heated to 80° C. While agitating the reacted compound, 300 g of toluene were slowly dripped into the compound, followed by cooling it to 30° C. Only precipitated novolak resin was collected, and 120 g of PGMEA was then added to the remaining compound and the temperature was increased to 80° C. Remaining toluene was removed by decompression distillation. The number average molecular weight was measured by GPC, showing that a fractionated novolak resin with a molecular weight of 4000 was obtained.

### Example 1

The above-obtained novolak resin and fractionated resin were used as polymer resins in the ratio of 30:70.

An LCD photoresist composition was produced by adding 4 g of sensitizer and 20 g of resins (6 g of novolak resin and 14 g of fractionated resin), 2 g of 2,3,4-trihydroxybenzophenone as a photosensitizer, and 74 g of PGMEA (propylene glycol methyl ether acetate) as an organic solvent, and then by agitating at 40 rpm at room temperature. A 5/5 mixture of 2,3,4,-trihydroxybenzophenone-1,2-naphthoquinonediazide-5-sulfonate and 2,3,4,4-tetrahydroxybenzophenone-1,2-naphthoquinonediazide-5-sulfonate was used as the above sensitizer.

An LCD circuit photoresist composition manufactured above was drop-applied to 0.7 T (thickness: 0.7 mm) glass plates while rotating them at a constant rate. The resulting glass plates were heat-dried at 115° C. for 90 seconds to obtain a photoresist film layer with a thickness of 1.50 μm on the glass. The resulting glass plates were exposed to ultraviolet light using a mask and then dipped into a 2.38% tetra methyl ammonium hydroxide aqueous solution for 60 seconds to remove the exposed portions and obtain photoresist patterns. After forming these patterns on the ITO glass, the glass was treated with an etchant, and the length of ITO unexposed by the etchant was measured.

### Example 2

An LCD circuit photoresist composition was synthesized with the same method as in the Example 1, except a 5/5 mixture ratio (20 g of resin=10 g of novolak resin+10 g of fractionated resin) was used.

### Example 3

An LCD circuit photoresist composition was synthesized with the same method as in the Example 1, except a 70:30 mixture ratio (20 g of resin=14 g of novolak resin+6 g of fractionated resin) was used.

### Comparative Example 1

An LCD circuit photoresist composition was synthesized with the same method as in the Example 1, except only novolak resin was used.

### Comparative Example 2

An LCD circuit photoresist composition was synthesized with the same method as in the Example 1, except only fractionated novolak resin was used.

### Experimental Example

Regarding the manufactured photoresist compositions from Examples 1 to 3 and Comparative Examples 1 and 2, the physical properties were as described in Table 1, found by the following methods.

A. Photosensitivity and Retention Ratio
original film thickness=thickness lost+thickness remained
retention ratio=(remaining thickness/original film thickness)

Photosensitivity was measured by calculating the energy needed to melt a film according to exposing energy, under the same developing conditions. The soft-baking step was performed at 115° C., then the retention ratio was measured after exposing and developing steps. The results regarding the differences of thickness before and after developing are presented in Table 1.

B. Heat Resistance

Tg (Glass Transition Temperature) is a method of expressing heat resistance measured by DSC.

C. Adhesion

The photoresist film on the ITO glass coated by an LCD circuit photoresist composition was treated with an etchant to remove the exposed ITO after obtaining desired patterns (fine lines and widths) during the developing step. Adhesion was tested by measuring the etched length of ITO unexposed by an etchant.

TABLE 1

| | Novolak | | Photosen- | Remainder | Heat | Adhe- |
|---|---|---|---|---|---|---|
| | resin | | sitivity | ratio | resistance | sion |
| Section | A¹ | B¹ | Eth (mJ/cm²) | (%) | (° C.) | (um) |
| Example 1 | 30 | 70 | 6.5 | 92 | 115 | 0.72 |
| Example 2 | 50 | 50 | 6.5 | 90 | 110 | 0.63 |
| Example 3 | 70 | 30 | 6.5 | 88 | 106 | 0.54 |
| Comp. | 100 | — | 6.5 | 63 | 102 | 0.67 |
| Example 1 | | | | | | |
| Comp. | — | 100 | 6.5 | 72 | 120 | 2.36 |
| Example 2 | | | | | | |

Note)
¹novolak A resin:m-cresol/p-cresol = 4/6 mixture
2. novolak B resin:m-cresol/p-cresol = 4/6 mixture fractionated

As shown in Table 1, the photoresist film photosensitive energy produced by photoresist compositions of Examples 1 to 3 had higher retention ratios compared with the photoresist film photosensitive energy using traditional photoresist compositions.

Furthermore, the photoresist layers produced by the LCD circuit photoresist compositions of the present invention had higher retention ratios compared with the photoresist layers produced by traditional photoresist compositions. Therefore, the physical properties as a photoresist layer of the present invention are excellent.

Furthermore, as shown in Table 1, the photoresist layers produced by photoresist compositions of Examples 1 to 3 may bring improved adhesion and alteration of the pattern profile in the hard-baking step after obtaining desired patterns (fine lines and widths) during the developing step.

As described above, the LCD circuit photoresist compositions of the present invention have excellent photosensitivity, retention ratio, resolution, contrast, heat resistance, adhesion, and stripper solubility, thus these photoresist compositions can be easily applied to industrial work places for better working environments.

1. An LCD circuit photoresist composition, comprising:
(a) mixed polymer resins comprising a novolak resin with a molecular weight ranging from 3,000 to 9,000 and a fractionated novolak resin with a molecular weight ranging from 3,500 to 10,000; (b) a diazide-type photosensitive compound; (c) a photosensitizer; and (d) organic solvents.

2. The LCD circuit photoresist composition according to claim 1, wherein the photoresist composition comprises (a) 5 to 30 wt. % of the mixed polymer resins comprising the novolak resin with a molecular weight ranging from 3,000 to 9,000 and the fractionated novolak resin with a molecular weight ranging from 3,500 to 10,000; (b) 2 to 10 wt. % of the diazide-type photosensitive compound; c) 0.1 to 10 wt. % of the photosensitizer; and (d) 60 to 90 wt. % of organic solvents.

3. The LCD circuit photoresist composition according to claim 1, wherein the mixture ratio of said novolak resin and fractionated novolak resin is 10 to 90 parts by weight: 90 to 10 parts by weight.

4. The LCD circuit photoresist composition according to claim 1, wherein the diazide-type photosensitive compound is a mixture of 2,3,4,4′-tetrahydroxybenzophenone-1,2-naphtoquinonediazide-5-sulfonate, and 2,3,4,-trihydroxybenzophenone-1,2-naphthoquinonediazide-5-sulfonate.

5. The LCD circuit photoresist composition according to claim 4, wherein the mixture ratio of 2,3,4,4′-tetrahydroxybenzophenone-1,2-naphthoquinonediazide-5-sulfonate and 2,3,4,-trihydroxybenzophenone-1,2-naphthoquinonediazide-5-sulfonate is 30 to 70 parts by weight: 70 to 30 parts by weight.

6. The LCD circuit photoresist composition according to claim 1, wherein the photosensitizer is at least one polyhydroxy compound selected from the group consisting of the following formulas 1, 2, 3, 4, and 5: 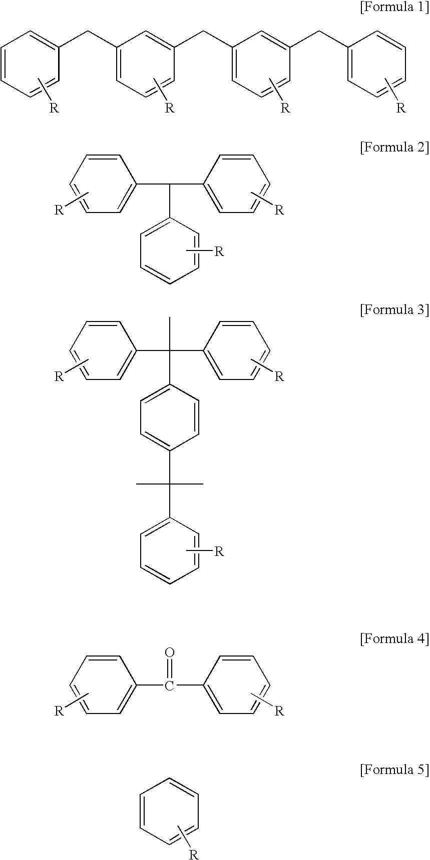
wherein R is hydrogen, —(CH₃)ₙ, —(CH₃CH₂)ₙ, —(OH)ₙ, or a phenyl group, respectively or simultaneously (n is an integral number of 0 to 5).

7. The LCD photoresist composition according to claim 6, wherein the polyhydroxy compound is 4,4-[1-[4-[1-(1,4-hydroxyphenyl)-1-methylethyl]phenyl]ethylidene]bisphenol(TPP A).

8. The LCD photoresist composition according to claim 6, wherein the polyhydroxy compound is 2,3,4,-trihydroxybenzophenone.

9. The LCD circuit photoresist composition according to claim 1, wherein the organic solvent is at least one selected from the group consisting of propyleneglycolmethyletheracetate (PGMEA), propyleneglycolmethyletheracetate (PGMEA) and ethyllactate (EL), 2-methoxyethylacetate (MMP), propyleneglycolmonomethylether (PGME), and a mixture thereof.

10. Semiconductor devices using the photoresist composition according to claim 1, wherein the composition is coated on a conductive metal layer or an insulating layer for forming a photoresist pattern by exposing and developing steps, and being removed by etching and stripping steps.
